(19) United States
(12) Patent Application Publication
(10) Pub. No.: US 2016/0380253 A1
(43) Pub. Date: Dec. 29, 2016

(54) METHOD FOR MANUFACTURING AN ELECTRODE PARTICULARLY FOR ELECTROCHEMICAL ENERGY STORAGE DEVICES, AS WELL AS AN ELECTRODE AND AN ELECTROCHEMICAL ENERGY STORAGE DEVICE

(71) Applicant: Airbus Defence and Space GmbH, Taufkirchen (DE)

(72) Inventors: Alexander OHNESORGE, Brunnthal (DE); Michael PILAWA, Muenchen (DE); Christian KARCH, Neubiberg (DE); Juergen STEINWANDEL, Uhdingen-Muehlhofen (DE)

(21) Appl. No.: 15/192,024

(22) Filed: Jun. 24, 2016

(30) Foreign Application Priority Data
Jun. 24, 2015 (EP) 15 173 709.5

(51) Int. Cl. H01M 4/04; H01M 4/66; H01M 4/583; H01M 10/0525

(52) U.S. Cl. CPC H01M 4/0404; H01M 10/0525; H01M 4/661; H01M 4/662; H01M 4/583; H01M 4/0471

(57) ABSTRACT

A method for manufacturing an electrode comprises the steps of applying a suspension of a suspension medium containing a solvent and electrically conductive carbon allotropes on a substrate, generating an electric field that penetrates the suspension and has a predefined field direction in order to align the carbon allotropes in the field direction, and removing the solvent from the suspension medium in order to harden the suspension in the aligned state of the carbon allotropes. A thusly manufactured electrode leads to a higher capacity, a higher charging and discharging rate, i.e. the delivery of a higher electric current, as well as shorter charging and discharging times of secondary batteries.

### CROSS-REFERENCE TO RELATED APPLICATIONS

This application claims priority to European Patent Application No. 15 173 709.5, filed 24 Jun. 2015, which is incorporated herein by reference in its entirety.

### TECHNICAL FIELD

The embodiments described herein relate to a method for manufacturing an electrode, particularly for electrochemical energy storage devices, as well as to an electrode and an electrochemical energy storage device.

### BACKGROUND

Electrochemical energy storage devices such as, e.g., lithium-ion batteries have a negative electrode and a positive electrode that are separated from one another by a membrane and surrounded by a preferably anhydrous electrolyte. The active material of the negative electrode, which is a cathode when the energy storage device is charged and an anode when it is discharged, usually consists of graphite or related carbons, in which a diffusion (intercalation) of lithium may take place. The active material of the positive electrode, which is an anode when the energy storage devices charged and a cathode when it is discharged, frequently comprises transition metal compounds such as lithium-metal oxide compounds. For example, LiCoO₂ and related compounds are widely used for this purpose.

When the energy storage device is charged, an electric potential difference exists between the active material of the negative electrode and the active material of the positive electrode. Lithium in ionized form may move through the electrolyte between the two electrodes, wherein this compensates the external current flow when the energy storage device is charged and discharged such that the electrodes largely remain electrically neutral. The lithium ions diffused in the negative electrode respectively release an electron that flows to the positive electrode via the external circuit. A corresponding number of lithium ions simultaneously migrate through the electrolyte from the negative to the positive electrode, where they are absorbed by the transition metal compound present at this location.

In order to increase the capacity of intercalation materials such as graphite, it is attempted, among other things, to use carbon allotropes such as graphenes (flakes, sheets, carbon nanotubes, carbon nanofibers) because graphite has a relatively low storage capacity for lithium ions and only limited accessibility for cations exists.

In the manufacture of the active material layer of an electrode with graphenes, it is common practice to use suspensions that are applied on a suitable substrate, for example of copper or another electrically conductive material, and subsequently hardened.

### SUMMARY

It is an objective of the embodiment to respectively propose an active material layer, particularly of negative electrodes for an energy storage device, as well as a suitable manufacturing method therefor, in which a significantly improved intercalation and simultaneously a high capacity of the active material are achieved. This objective is attained by means of a method for manufacturing an electrode with the characteristics of independent claim 1. Advantageous embodiments and enhancements are disclosed in the dependent claims and the following description.

It is proposed a method for manufacturing an electrode that comprises the steps of applying a suspension of a suspension medium containing a solvent and electrically conductive carbon allotropes on a substrate, generating an electric field that penetrates the suspension and has a predefined field direction relative to the substrate in order to align the carbon allotropes in the field direction, and removing the solvent from the suspension medium in order to harden the suspension, wherein the alignment of the carbon allotropes is preserved.

The substrate, which may act as current collector and defines the external shape of the electrode, should in the context of the inventive method be interpreted as a base layer that is wetted with the suspension is uniformly as possible. As initially mentioned, this material may consist of copper or another electrically conductive material, for example aluminum, or an alloy thereof. The specific structure of the substrate is irrelevant to the inventive method, but conventionally used preconditioning methods such as, for example, collector foils may be used. Among other things, these preconditioning methods include a plasma pretreatment for eliminating contaminants and for the chemical activation, the application of primer layers for achieving an improved bond of the active material, as well as structuring of the surface.

The suspension containing a suspension medium with a solvent and, depending on the respective requirements, various additives such as binders and conductive additives, as well as the electrically conductive carbon allotropes, forms a slurry layer on the substrate, in which the carbon allotropes are contained in a freely movable fashion at least to a certain degree. The following systems are widely used as suspension medium:

NMP solvents (N-methyl-2-pyrrolidone) with PVDF binder (polyvinylidene fluoride) and conductive additives

water-based solvents with SBR binder (styrene-butadiene rubber) and CMC binder (carboxymethyl cellulose).

The carbon allotropes may be realized in any form and in different sizes is long as they are electrically conductive and may be suspended.

The electric field may be generated with the aid of separate electrodes provided for this purpose such that it extends at least through the suspension. The substrate itself may optionally form one of the electrodes required for this purpose. A dipole moment is thereby created on the carbon allotropes such that they align in the field direction of the electric field. This effect is promoted with the selection of a suitable suspension medium and a suitable mixing ratio.

The thusly obtained state with aligned carbon allotropes is subsequently “frozen” in that the solvent is removed from the suspension again such that an active material layer is produced thereof. Consequently, the carbon allotropes form a homogenously aligned layer on the substrate such that the accessibility for the (cat)ions to be diffused is significantly improved in comparison with a geometrically random arrangement within such an active material layer. The surface of the carbon allotropes and the volume of the active material are utilized much better for the electrochemical processes of an electrochemical energy storage device. In addition to the increased capacity, for example, of graphenes or carbon nanotubes in comparison with conventional graphite-based materials, the diffusion of the cations is promoted, i.e. the diffusion paths are significantly shortened, which in turn positively affects the attainable amplitudes of the charging and discharging currents. Consequently, the geometric alignment of the carbon allotropes promotes and accelerates the diffusion of the ions exchanged in the energy storage device. An electrochemical energy storage device with a thusly manufactured electrode therefore has an improved high-current capability, as well as an improved specific power density. Consequently, the duration of the charging and discharging processes may be significantly reduced, which in turn provides significant advantages with respect to the use of the energy storage device.

In an advantageous embodiment, the carbon allotropes are macromolecular carbon allotropes. These include crystalline forms of carbon that have a much more complex structure than graphite and include, for example, graphenes, carbon nanotubes and carbon nanofibers. The storage capacity is significantly improved in comparison with graphite-based materials such that, for example, the utilization of graphene nanoflakes results at a voltage of 0.7 Volt in a capacity of 780 mAh/g in comparison with Li/Li+ whereas the utilization of graphite would result in a capacity of approximately 370 mAh/g. Consequently, the carbon allotropes may be selected from a group of carbon allotropes, wherein the group comprises graphene flakes, carbon nanotubes, carbon nanofibers and fullerenes.

The removal of the solvent from the suspension may be realized by heating the suspension in order to evaporate the solvent. The suspension may be heated by actively supplying heat, in a contact-based fashion via the substrate, with thermal radiation or alternatively with another high-energy radiation such as, for example, microwaves. The evaporation of the solvent should preferably take place in such a way that the previously aligned structure of the carbon allotropes is not disturbed during the evaporation process. In this context, it may be advantageous to limit the heat supplied to a certain heat flow rate and thereby limit the evaporation rate. It may also be advantageous to maintain the electric field during at least part of the heating process.

The application of the carbon allotropes may furthermore be realized with the targeted growth of carbon nanotubes, e.g. by utilizing chemical vapor deposition, in which hydrocarbons are catalytically broken down such that carbon nanotubes grow on the substrate. The formation of the carbon nanotubes may be respectively defined or promoted due to the effect of the electric field.

The substrate may have a plane surface, wherein the carbon allotropes are aligned orthogonal to the plane surface. The orthogonal alignment relative to a principal plane of the current collector or the storage medium is particularly advantageous. Consequently, the carbons allotropes are in the assembled state of the energy storage device directed toward the opposite positive electrode and the lithium ions may penetrate better and faster into the structure of the active material of the electrode, i.e. into the intermediate spaces between the carbon allotropes. In addition to a promoted diffusion, which in turn leads to higher C-rates during a charging and a discharging process, lower-lying regions of the active material may be better reached and utilized. In comparison with systems that are not manufactured with the method described herein, this leads to an increase of the storage capacity, as well as to a significant reduction of the charging time.

The embodiment furthermore pertains to an electrode for an energy storage device that is manufactured in accordance with the above-described method. The electrode preferably is a negative electrode for an energy storage device and may improve the properties of the energy storage device in the above-described fashion due to its structuring obtained during the manufacture. However, the electrode manufactured with the above-described method may also be used as a positive electrode, for example, in an energy storage device that is based on a lithium-sulfur system.

The embodiment likewise pertains to an energy storage device that comprises at least one such electrode. The energy storage device is preferably based on lithium-ion technology and consequently comprises at least one electrode, particularly, but not exclusively or necessarily, a negative electrode, which is manufactured with the above-described method.

### BRIEF DESCRIPTION OF THE DRAWINGS

The various embodiments will hereinafter be described in conjunction with the following drawing figures, wherein like numerals denote like elements, and:

Other characteristics, advantages and potential applications of the present embodiment result from the following description of exemplary embodiments and the figures. In this respect, all described and/or graphically illustrated characteristics form the object of the embodiment individually and in arbitrary combination, namely regardless of their composition in the individual claims or their references to other claims. In the figures, identical or similar objects are furthermore identified by the same reference symbols.

FIG. 1 shows a schematic illustration of a first step of the manufacturing method in the form of the application of a suspension.

FIG. 2 shows an applied electric field after the first step and the aligned graphene structures.

FIG. 3 shows the hardening of the suspension.

### DETAILED DESCRIPTION

The following detailed description is merely exemplary in nature and is not intended to limit the disclosed embodiments or the application and uses thereof. Furthermore, there is no intention to be bound by any theory presented in the preceding background section.

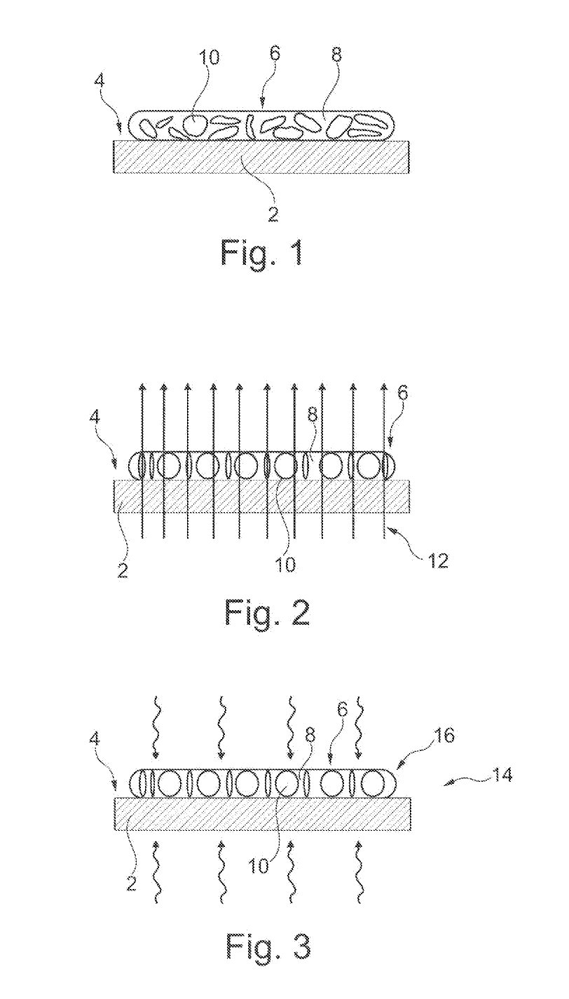

FIG. 1 shows a substrate 2 with a plane surface 4, on which a suspension 6 of a suspension medium 8 containing a solvent and carbon allotropes 10 is applied. For example, these carbon allotropes are realized in the form of graphene flakes and therefore have a laminar shape of different sizes. The carbon allotropes 10 are freely movable in the suspension 6 at least to a certain degree and therefore may have different orientations.

The suspension 6 may be applied with suitable application methods that may include doctoring, the application with the aid of an application roller, spraying methods or other methods comprising one or more application steps. The suspension medium 8 may already be mixed with corresponding carbon allotropes 10 beforehand and stored in a mixing container or the carbon allotropes 10 and the suspension medium 8 are respectively applied in the form of individual layers, particularly in an alternating fashion.

According to FIG. 2, an electric field 12 is generated after the complete application of the suspension 6, wherein this electric field extends through the suspension 6. This electric field may be generated by a pair of electrodes that are connected to a direct voltage of suitable intensity. For example, the substrate 2 may be used as one of the electrodes whereas the second electrode is arranged at a distance therefrom on an opposite side of the suspension 6 referred to the substrate 2.

An electric dipole moment is induced due to the effect of the electric field 12. Since dipole moments induced, in particular, by means of displacement polarization are much lower than permanent dipole moments for polar molecules, it is advantageous to ensure a relatively strong electric field. A sufficient mobility of the carbon allotropes 10 in the suspension medium 8 must be ensured and the carbon allotropes 10 must be allotted sufficient time for the alignment.

The carbon allotropes 10 may align themselves such that they follow the field lines of the electric field 12. For example, the electric field 12 extends orthogonal to the substrate 2 such that the carbon allotropes 10 consequently also align themselves orthogonal thereto. The ion transport into the active material is thereby improved.

As an alternative to the application of the suspension in accordance with FIG. 1, it would also be conceivable to utilize a directionally controlled growth of carbon nanotubes or other carbon allotropes such that the same structure is ultimately achieved in the suspension 6.

According to FIG. 3, the solvent is subsequently removed from the suspension medium again in accordance with established methods. These may include, for example, a contact-based heat supply from the substrate 2, thermal radiation or other forms of high-energy radiation, e.g., microwaves or lasers, such that the solvent evaporates from the suspension medium 8. After they have assumed the desired geometric orientation, the carbon allotropes 10 subsequently remain on the surface 4 of the substrate 2 in their aligned form, wherein the binder and the conductive additives from the suspension medium 8 likewise remain on the surface of the substrate and thereby form a structured active material layer 16 of the electrode 14. The entire manufacture of aligned active material layers may be integrated into a roll-to-roll process of the type nowadays used for the manufacture of battery components and cells.

Due to the geometrically ordered and aligned carbon allotropes in the active materials of the electrochemical energy storage device, the described method not only makes it possible to increase the storage capacity due to a superior utilization of the entire active material layer, but also to increase the attainable charging and discharging rates and to realize an improved power density of the storage device.

As a supplement, it should be noted that “comprising” does not exclude any other elements or steps, and that “a” or “an” does not exclude a plurality. It should furthermore be noted that characteristics or steps that were described with reference to one of the above exemplary embodiments may also be used in combination with other characteristics or steps of other above-described exemplary embodiments. Reference symbols in the claims should not be interpreted in a restrictive sense.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the embodiment in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the embodiment as set forth in the appended claims and their legal equivalents.

1. A method for manufacturing an electrode, comprising the steps of:
applying a suspension of a suspension medium containing a solvent and electrically conductive carbon allotropes on a substrate;
generating an electric field that penetrates the suspension and has a predefined field direction in order to align the carbon allotropes in the field direction; and
removing the solvent from the suspension medium in order to harden the suspension, wherein the alignment of the carbon allotropes is preserved.

2. The method of claim 1, wherein the carbon allotropes are macromolecular carbon allotropes.

3. The method of claim 2, wherein the carbon allotropes are selected from a group of carbon allotropes, with said group comprising:
graphene, particularly graphene flakes,
fullerenes,
carbon nanotubes, and
carbon nanofibers.

4. The method of claim 1, wherein the removal of the solvent from the suspension medium is realized by heating the suspension in order to evaporate the solvent from the suspension medium.

5. The method of claim 4, wherein the solvent is heated with high-energy radiation.

6. The method of claim 1, wherein the substrate comprises an electrically conductive current collector.

7. The method of claim 1, wherein the substrate has a plane surface and the carbon allotropes are aligned orthogonal to the plane surface.

8. An electrode for an energy storage device, which is manufactured in accordance with the method of claim 1.

9. An energy storage device, comprising at least one electrode of claim 8.
